(19) United States
(12) Patent Application Publication
(10) Pub. No.: US 2009/0221740 A1
(43) Pub. Date: Sep. 3, 2009

(54) NOVEL COMPOSITIONS, METHODS, AND POLYMERS

(75) Inventor: Elena E. Sheina, Pittsburgh, PA (US)

Correspondence Address: FOLEY AND LARDNER LLP;SUITE 500, 3000 K STREET NW, WASHINGTON, DC, 20007, US

(73) Assignee: Plextronics, Inc.

(21) Appl. No.: 12/371,556

(22) Filed: Feb. 13, 2009

Related U.S. Application Data
(60) Provisional application No. 61/029,255, filed on Feb. 15, 2008.

(51) Int. Cl. C08L 41/00; C08G 75/02; C08F 228/06; C08G 77/04

(52) U.S. Cl. 524/548; 528/380; 526/256; 526/257; 528/27; 524/609; 257/40

(57) ABSTRACT

A composition comprising a copolymer comprising DTP units for use in, for example, low band gap materials including uses in organic photovoltaic active layers. The band gap and other properties can be engineered by copolymerization methods including selection of monomer structure and ratio of monomer components. In addition, a dimer adapted for making alternating copolymers further comprising one first monomer moiety comprising at least one DTP moiety compound covalently linked to one second monomer moiety comprising at least one non-DTP moiety or a different DTP moiety. The composition can be copolymerized to form an alternating copolymer that can be further processed to form a polymeric film used in a printed organic electronic device. A series of novel alternating dithieno[3,2-b:2′,3′-d]pyrrole (DTP)-based donor repeat unit copolymers were designed that would allow fabrication of materials with tailor made electronic and/or mechanical properties that can be easily manipulated through molecules chemical structure and potentially result in long term stability under ambient conditions that can be advantageous for use in organic electronics (e.g., OPVs, OLEDs, OFETs).

### CROSS-REFERENCE TO RELATED APPLICATIONS

This application claims priority to U.S. provisional application 61/029,255 filed Feb. 15, 2008 to Sheina, which is hereby incorporated by reference in its entirety.

### BACKGROUND

Conjugated organic polymers, or intrinsically conductive polymers, have become an economically important class of conductive material in a variety of applications such as, for example, organic light-emitting diodes (OLEDs), field effect transistors (FET), photovoltaic devices (OPVs), and printed electronics generally. Commercial interest arises in part due to the advances in the ability to control the optical and electronic properties of the polymers. In particular, an important aspect of conjugated polymers is the ability to tune the band gap of the polymer, and a particular need exists in the development of new polymeric architectures with specifically designed electronic and optical properties, including lower band gaps, with commercially useful properties. See, for example, Bundgaard et al., “Low Band Gap Polymers for Organic Photovoltaics,” Solar Energy Materials and Solar Cells, 91 (2007), 954-985.

### SUMMARY

Embodiments described herein include, among other things, compositions, compounds, devices, methods of making, and methods of using.

For example, one embodiment provides a composition comprising at least one copolymer, the copolymer comprising at least one first dithieno[3,2-b:2′,3′-d]pyrrole (DTP) repeat unit.

Another embodiment provides at least one composition comprising a mixture comprising: (i) at least one p-type material, (ii) at least one n-type material, wherein the at least one p-type material comprises at least one copolymer, the copolymer comprising at least one first dithieno[3,2-b:2′,3′-d]pyrrole (DTP) repeat unit.

Another embodiment provides a composition comprising at least one dimer, the dimer comprising at least one first dithieno[3,2-b:2′,3′-d]pyrrole (DTP) repeat unit and at least one non-DTP repeat unit.

Another embodiment provides a method of making a composition comprising at least one dimer, the dimer comprising at least one first dithieno[3,2-b:2′,3′-d]pyrrole (DTP) repeat unit and at least one non-DTP repeat unit, the method comprising covalently linking the DTP repeat unit and the non-DTP repeat unit.

Another embodiment provides a composition comprising at least one dimer, the dimer comprising two different dithieno[3,2-b:2′,3′-d]pyrrole (DTP) repeat units.

Another embodiment provides a composition comprising at least one copolymer, the copolymer comprising at least one first dithieno[3,2-b:2′,3′-d]pyrrole (DTP) repeat unit, wherein the DTP repeat unit is represented by:

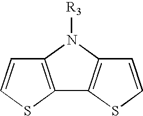

wherein R₃ is an optionally substituted alkyl, an optionally substituted aryl, an optionally substituted alkenyl, or an optionally substituted alkynyl; and the copolymer further comprises at least one non-DTP unit or at least one different DTP unit in the copolymer backbone.

Another embodiment provides an electronic device comprising a composition comprising at least one copolymer, the copolymer comprising at least one first dithieno[3,2-b:2′,3′-d]pyrrole (DTP) repeat unit.

Another embodiment provides a composition comprising a mixture comprising: (i) at least one p-type material, (ii) at least one n-type material, wherein the at least one p-type material comprises copoly{N-[1(2′-ethylhexyl)-3-ethylheptanyl]dithieno[3,2-b;2′,3′-d]pyrrole-2,6-diyl-alt-4,7-di(2-thienyl)-2,1,3-benzothiadiazole-5′,5″-diyl} and wherein the at least one n-type material comprises at least one fullerene derivative comprising at least one [6,6] fullerene bonding site wherein both carbon atoms of the [6,6] bonding site are covalently bonded to a group R.

Another embodiment provides a copolymer represented by:

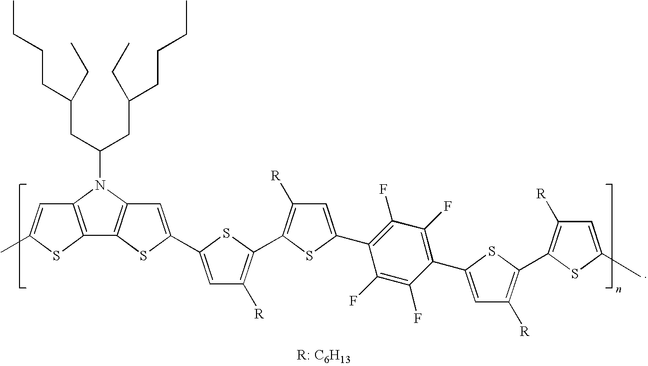

In this embodiment, the R group can also be an alkyl group such as, for example a C1-C25 alkyl group. The R group can be a group which facilitates solubility of the polymer.

Another embodiment provides composition comprising a mixture comprising: (i) at least one p-type material, (ii) at least one n-type material, wherein the at least one p-type material comprises at least one copolymer, the copolymer represented by:

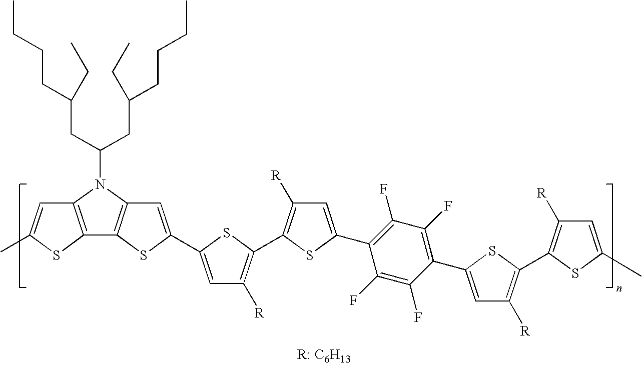

In one embodiment, a series of novel alternating dithieno[3,2-b:2′,3′-d]pyrrole (DTP)-based donor repeat unit copolymers were designed that would allow fabrication of materials with tailor made electronic and/or mechanical properties that can be easily manipulated through molecules chemical structure and can, at least in some embodiments, result in long term stability under ambient conditions, including resistance to oxidation.

Examples of one or more advantages for at least some embodiments can be: fine control of copolymer microstructure, ability to tune the electronic properties of the copolymer, reduced band gap, improved mobility, stable oxidation state, general environmental stability, good solubility, good processability, and/or long term resistance to oxidation.

### BRIEF DESCRIPTION OF THE FIGURES

FIG. 1 illustrates synthesis of monomers.

FIG. 2 illustrates polymerization.

FIG. 3 illustrates examples of X groups in a T-X-T moiety, where T is thiophene.

FIG. 4 illustrates examples of non-DTP types of repeat units.

### DETAILED DESCRIPTION

### Introduction

All references cited herein are incorporated by reference in their entirety.

Priority U.S. provisional application 61/029,255 filed Feb. 15, 2008 to Sheina is hereby incorporated by reference in its entirety including the figures, claims, and examples.

Copolymers and copolymer architecture are generally known in the art. See for example Billmeyer, Textbook of Polymer Science, 3^{rd} Ed, 1984 (e.g., Chapter 5); Concise Encyclopedia of Polymer Science and Engineering, (Kroschwitz, Ed.), 1990 “Copolymerization” and “Alternating Copolymers.” As an example, copolymers include block copolymers, segmented copolymers, graft, alternating copolymers, random copolymers, and the like.

Conjugated polymers are also generally known in the art. The PDTPs described herein are one example. Other examples include polythiophenes (including regioregular polythiophenes), polypyrroles, poly(phenylene vinylenes), polyanilines, and the like.

U.S. Pat. No. 6,166,172 describes the GRIM method of forming, for example, a regioregular poly (3-substituted thiophene) from a polymerization reaction. The method proceeds by combining, for example, a soluble thiophene having at least two leaving groups with an organomagnesium reagent to form a regiochemical isomer intermediate, and adding thereto an effective amount of, for example, Ni(II) complex to initiate the polymerization reaction.

Organic electronic devices are known in the art.

Provisional patent application Ser. No. 60/612,640 filed Sep. 24, 2004, to Williams, et al. (“HETEROATOMIC REGIOREGULAR POLY(3-SUBSTITUTED THIOPHENES) FOR ELECTROLUMINESCENT DEVICES”), and U.S. Ser. No. 11/234,374 filed Sep. 26, 2005, are hereby incorporated by reference in their entirety, including the description of the polymers, the figures, and the claims.

Provisional patent application Ser. No. 60/612,641 filed Sep. 24, 2004, to Williams, et al. (“HETEROATOMIC REGIOREGULAR POLY (3-SUBSTITUTED THIOPHENES) FOR PHOTOVOLTAIC CELLS”), and U.S. Ser. No. 11/234,373 filed Sep. 26, 2005, are hereby incorporated by reference in their entirety, including the description of the polymers, the figures, and the claims.

Provisional patent application Ser. No. 60/651,211 filed Feb. 10, 2005, to Williams, et al. (“HOLE INJECTION LAYER COMPOSITIONS”), and U.S. Ser. No. 11/350,271 filed Feb. 9, 2006, are hereby incorporated by reference in their entirety, including the description of the polymers, the figures, and the claims.

Priority provisional patent application Ser. No. 60/661,934 filed Mar. 16, 2005, to Williams, et al., and U.S. Ser. No. 11/376,550 filed Mar. 16, 2006, are hereby incorporated by reference in their entirety, including the description of the polymers, the figures, and the claims.

Provisional patent application Ser. No. 60/812,916 filed Jun. 13, 2006 (“ORGANIC PHOTOVOLTAIC DEVICES COMPRISING FULLERENES AND DERIVATIVES THEREOF”), U.S. patent application Ser. No. 11/743,587 filed May 2, 2007, and U.S. patent application Ser. No. 12/040,776 filed Feb. 29, 2008, are hereby incorporated by reference in their entirety, including the descriptions of the polymers, the n-components including indene derivatives, the figures, and the claims.

Provisional patent application Ser. No. 60/915,632 filed May 2, 2007 (“SOLVENT BLENDS IN ACTIVE LAYER CONDUCTING POLYMER TECHNOLOGY FOR PRINTED ELECTRONIC DEVICES”), and U.S. patent application Ser. No. 12/113,058 filed Apr. 30, 2008, are hereby incorporated in their entirety, including the description of the polymers, the solvent blends, the figures and the claims.

Provisional patent application Ser. No. 61/016,420 filed Dec. 21, 2007, to Laird, et al. (“ORGANIC PHOTOVOLTAIC DEVICES COMPRISING FULLERENES AND DERIVATIVES THEREOF AND IMPROVED METHODS OF MAKING FULLERENE DERIVATIVES”) is hereby incorporated by reference in its entirety, including the description of the polymers, the figures, and the claims.

Additional description of methods may be found in, for example, McCullough et al., J. Org. Chem., 1993, 58, 904-912, and U.S. Pat. No. 6,602,974, including formation of block copolymers, to McCullough, et al.

Additional description can be found in the articles, “The Chemistry of Conducting Polythiophenes,” by Richard D. McCullough, Adv. Mater. 1998, 10, No. 2, 93-116, and references cited therein, and Lowe, et al., Adv. Mater. 1999, 11, 250, which are hereby incorporated by reference in its entirety. The Handbook of Conducting Polymers, 2nd Ed., 1998, Chapter 9, by McCullough, et al., “Regioregular, Head-to-Tail Coupled Poly(3-alkylthiophene) and its Derivatives,” pages 225-258, is also hereby incorporated by reference in its entirety.

For preparing polymers, Grignard metathesis reactions are known in the art, an example of which is described by L. Boymond et al., Angew. Chem. Int. Ed., 1998, 37, No. 12, pages 1701-1703, which is incorporated herein by reference in its entirety. If a side group R on a monomer is reactive with the organomagnesium reagent, a protective group can be coupled with the R-group to prevent the R-group from taking part in the synthesis. The use of protective groups with a reactive R-group is well known in the art, as described by Greene and Greene, “Protective Groups in Organic Synthesis,” John Wiley and Sons, New York (1981), which is incorporated herein by reference. One skilled in the art can use protective groups and deprotection synthetic strategies in order to introduce certain functional groups which may otherwise be undesirably reactive under certain desired reaction conditions. See, for example, March's Advanced Organic Chemistry, Reactions, Mechanisms, and Structure, 6^{th} Ed, 2007.

“Optionally substituted” groups refers to functional groups that may be substituted or unsubstituted by additional functional groups. When a group is unsubstituted by an additional group it may be referred to as a group name, for example alkyl or aryl. When a group is substituted with additional functional groups it may more generically be referred to as substituted alkyl or substituted aryl, respectively.

“Aryl” refers to, for example, an aromatic carbocyclic group of from 6 to 20 carbon atoms having a single ring (e.g., phenyl) or multiple condensed rings (e.g., naphthyl or anthryl) which condensed rings may or may not be aromatic provided that the point of attachment is at an aromatic carbon atom. Preferred aryls include, for example, phenyl, naphthyl, and the like.

“Alkyl” refers to, for example, straight chain and branched alkyl groups having from 1 to 20 carbon atoms, or from 1 to 15 carbon atoms, or from 1 to 10, or from 1 to 5, or from 1 to 3 carbon atoms. This term is exemplified by groups such as, for example, methyl, ethyl, n-propyl, iso-propyl, n-butyl, t-butyl, n-pentyl, ethylhexyl, dodecyl, isopentyl, and the like.

“Substituted alkyl” refers to, for example, an alkyl group having from 1 to 3, and preferably 1 to 2, substituents selected from the group consisting of alkoxy, substituted alkoxy, acyl, acylamino, acyloxy, amino, substituted amino, aminoacyl, aryl, substituted aryl, aryloxy, substituted aryloxy, cyano, halogen, hydroxyl, nitro, carboxyl, carboxyl esters, cycloalkyl, substituted cycloalkyl, heteroaryl, substituted heteroaryl, heterocyclic, and substituted heterocyclic.

“Alkoxy” refers to, for example, the group “alkyl-O—” which includes, by way of example, methoxy, ethoxy, n-propyloxy, iso-propyloxy, n-butyloxy, t-butyloxy, n-pentyloxy, 1-ethylhex-1-yloxy, dodecyloxy, isopentyloxy, and the like. Another example of alkoxy is alkoxyalkoxy or alkoxyalkoxyalkoxy, and the like.

“Substituted alkoxy” refers to, for example, the group “substituted alkyl-O—.” “Alkenyl” refers to, for example, alkenyl group preferably having from 2 to 6 carbon atoms and more preferably 2 to 4 carbon atoms and having at least 1 and preferably from 1-2 sites of alkenyl unsaturation. Such groups are exemplified by vinyl, allyl, but-3-en-1-yl, and the like.

“Substituted alkenyl” refers to, for example, alkenyl groups having from 1 to 3 substituents, and preferably 1 to 2 substituents, selected from the group consisting of alkoxy, substituted alkoxy, acyl, acylamino, acyloxy, amino, substituted amino, aminoacyl, aryl, substituted aryl, aryloxy, substituted aryloxy, cyano, halogen, hydroxyl, nitro, carboxyl, carboxyl esters, cycloalkyl, substituted cycloalkyl, heteroaryl, substituted heteroaryl, heterocyclic, and substituted heterocyclic with the proviso that any hydroxyl substitution is not attached to a vinyl (unsaturated) carbon atom.

“Aryloxy” refers to, for example, the group aryl-O— that includes, by way of example, phenoxy, naphthoxy, and the like.

“Alkynyl” refers to, for example, an alkynyl group preferably having from 2 to 6 carbon atoms and more preferably 2 to 3 carbon atoms and having at least 1 and preferably from 1-2 sites of alkynyl unsaturation.

“Substituted alkynyl” refers to, for example, an alkynyl group having from 1 to 3 substituents, and preferably 1 to 2 substituents, selected from the group consisting of alkoxy, substituted alkoxy, acyl, acylamino, acyloxy, amino, substituted amino, aminoacyl, aryl, substituted aryl, aryloxy, substituted aryloxy, cyano, halogen, hydroxyl, nitro, carboxyl, carboxyl esters, cycloalkyl, substituted cycloalkyl, heteroaryl, substituted heteroaryl, heterocyclic, and substituted heterocyclic.

“Conjugated polymer” refers to, for example, polymers comprising at least some conjugated unsaturation in the backbone.

“A polythiophene” or “polythiophene” refers to, for example, polymers comprising a thiophene in the backbone including polythiophene, derivatives thereof, and copolymers and terpolymers thereof.

“Regioregular polythiophene” refers to, for example, polythiophene having high levels of regioregularity including for example at least 80%, or at least 90%, or at least 95%, or at least 98%, or at least 99%.

It is understood that in all substituted groups defined above, polymers arrived at by defining substituents with further substituents to themselves (e.g., substituted aryl having a substituted aryl group as a substituent which is itself substituted with a substituted aryl group, etc.) are not intended for inclusion herein. In such cases, the maximum number of such substituents is three. That is to say that each of the above definitions is constrained by a limitation that, for example, substituted aryl groups are limited to -substituted aryl-(substituted aryl)-substituted aryl.

Similarly, it is understood that the above definitions are not intended to include impermissible substitution patterns (e.g., methyl substituted with 5 fluoro groups or a hydroxyl group alpha to ethenylic or acetylenic unsaturation). Such impermissible substitution patterns are well known to the skilled artisan.

Other terms used herein are defined as follows, unless the context makes clear otherwise.

### Copolymer Comprising DTP

Copolymers are known in the art. Copolymers can be used in photovoltaic cells. See, for example, US Patent Publication 2008/0121281 published May 29, 2008.

And, the DTP structure is known in the art. For example, homopolymers comprising the DTP structure in a repeat unit are known (References for homopolymers: (a) Berlin, A.; Pagani, G.; Zotti, G.; Schiavon, G. Makromol. Chem. 1992, 193, 399; (b) Pagani, G. A. Heterocycles 1994, 37, 2069; (c) Kenning, D. D.; Ogawa, K.; Rothstein, S. D.; Rasmussen, S. C. Polym. Mater. Sci. Eng. 2002, 86, 59; (d) Ogawa, K.; Rasmussen S. C. J. Org. Chem. 2003, 68, 2921), (e) Ogawa et al., Macromolecules, 2006, 39, 1771-1778, and these DTP structures can be used in copolymers as described herein. The copolymer microstructure can be engineered to fine-tune the band gap and other electronic and optical properties. For example, a target band gap or band gap range can be selected and then the copolymer engineered to match the target. For example, a band gap of about 1.8 eV can be targeted. In addition, the monomer unit structure can be varied. In addition, the ratio of different monomers can be varied.

In one example, poly (N-substituted dithieno[3,2-b:2′,3′-d]pyrrole)s (PDTPs) can be soluble conjugated polymers that have advantages over regioregular poly (3-alkythiophene)s in terms of their reduced band gap energy and very stable oxidized state; see, for example, Ogawa et al., Macromolecules, 2006, 39, page 1771; Koeckelberghs et al., Macromolecules, 2005, 38, page 4545. Additionally, in solutions PDTPs appear as already highly conjugated, rigid rods, and hence when they transition from solution to film, only a very small red-shift was observed, as compared to the large red-shift of the regioregular poly(3-alkythiophene)s; see, for example, Koeckelberghs et al., Macromolecules, 2007, 40, page 4173, which is hereby incorporated by reference in its entirety. The reference describes synthesis of monomers and polymers.

Examples of the DTP structure can be represented by:

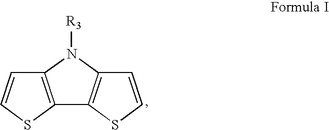

or more particularly,

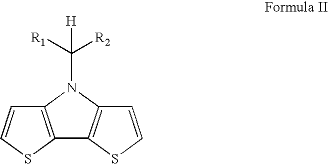

Wherein R1, R2, and R3 can be, for example, any group which is compatible with the synthesis of DTP units and compatible with subsequent polymerization and copolymerization steps. Protective groups can be used as appropriate. For example, R1, R2, and R3 can be adapted to provide or enhance solubility in the polymer. Or they can provide enhanced resistance to oxidation.

In a preferred embodiment, groups R1, R2, and/or R3 can comprise branched alkyl groups including, for example, ethylhexyl. The groups optionally may be substituted. Branched alkyl groups, both substituted and unsubstituted, are known in the art. See, for example, US Patent Publication 2008/0315751 published Dec. 25, 2008 to Sheina et al., which is hereby incorporated by reference in its entirety.

These groups R1, R2, and R3 can be, for example, optionally substituted hydrocarbon moieties. In some cases, one can introduce one or more heteroatoms, such as oxygen, into the R1, R2, and R3 groups, although, this may be difficult in many cases and unneeded in many cases. Examples include hexyl, octyl, decyl, octadecyl, t-butyl, 2-ethylhexyl, and p-hexylphenyl. Examples can comprise mixed aryl and alkyl substituents. Example can include C6-C24 moieties.

More particularly, R3 can be, for example, an optionally substituted alkyl, an optionally substituted aryl, an optionally substituted alkenyl, an optionally substituted alkynyl, and the like. R3 can bond to the pyrrole ring through a carbon atom. R3 can comprise one or more chiral centers.

R3 can be further represented as shown in Formula II including the R1 and R2 groups.

Substituents R1 and R2 independently can be, for example, the same or different and can impart better solubility and processability to the polymer.

More particularly, R1 and R2 can be, for example, an optionally substituted alkyl, an optionally substituted alkyl, an optionally substituted alkenyl, an optionally substituted alkynyl, and the like. In some cases, R1 or R2 can be hydrogen.

R1 and R2 can be, for example, independently alkyl groups including linear or branched alkyl groups including, for example, hexyl, octyl, decyl, octadecyl, t-butyl, 2-ethylhexyl, and p-hexylphenyl. The carbon range for R1 and R2 can be, for example, C5-C18, or C6-C15. The group R1 or R2 can have a chiral center if desired.

Other examples for R1 and R2 and R3 include C1-C20 alkyl, C1-C20 alkoxy, aryl, heteroaryl, C3-C20 cycloalkyl, and C3-C20 heterocycloalkyl.

In another embodiment, the DTP repeat unit can be represented by:

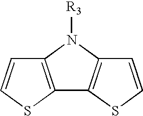

wherein R3 is a protecting group which can be thermally removed. Examples for R3 include t-BOC, t-butyloxycarbonyl. This can be particularly useful in, for example, an HIL/OLED or conductive/electrodes/coatings applications. The protective group can be removed upon casting a film or, if needed, in solution, which can make these types of copolymers/polymers insoluble and conductive (when reacted with dopant molecules/polymers).

The copolymer can comprise at least one DTP unit, or can comprise a plurality of DTP units, different from each other, such as, for example, at least two different DTP units.

The copolymer can also comprise non-DTP units, as described further below.

In one embodiment, the copolymer comprises only DTP units.

In another embodiment, the copolymer comprises at least one DTP unit and at least one non-DTP unit.

In one embodiment, two different monomers are copolymerized including at least one DTP monomer.

The degree of polymerization for the copolymer is not particularly limited but can be for example 2 to 500,000 or 5 to 100,000 or 10 to 10,000.

In one embodiment, the dimer can comprise one unit which functions as a donor, and a second unit which functions as an acceptor relative to the donor. For example, the DTP moiety can be an electron donor. The non-DTP moiety can be an electron acceptor.

One embodiment provides polymers such as the following wherein R can be any group compatible with the larger structure including, for example, alkyl such as n-hexyl:

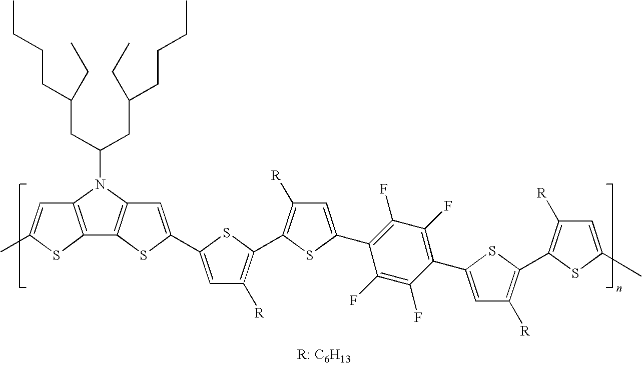

and the group bonded to nitrogen can comprise, for example, at least one, or at least two branched alkyl groups such as, for example, ethylhexyl.

In the copolymer, more than one donor moiety can be present. For example, a first donor moiety can be DTP, and a second donor moiety can be a non-DTP donor. An example for non-DTP donor including, for example, can be found in Usta et al., J. Am. Chem. Soc., 2006, 128, 9034-9035, which is hereby incorporated by reference in its entirety including structures and schemes. In particular, siloles can be used including a silicon-containing moiety TS6T1 can be used. The units can be represented by:

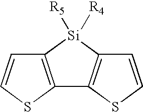

Wherein R4 and R5 can be as described for R1, R2, and R3 above for DTP units. For example, R4 and R5 can be an alkyl such as hexyl (or branched alkyl).

### Dimer Comprising DTP and Alternating Copolymer

In another embodiment, a dimer is first formed with units of two different monomers, and then an alternating copolymer is formed from polymerization of the dimer. For example, a dimer which can be represented as A-B can be subjected to polymerization to form an alternating copolymer which can be represented by -[A-B]ₙ— wherein A represents a DTP repeat unit and B represents a non-DTP repeat unit, or wherein A represents a first DTP unit and B represents a second different DTP unit such as for example -[DTP₁-DTP₂]ₙ-. The B unit can itself be a dimer, or a trimer, or a tetramer, and the like.

The dimer can be also represented as below:

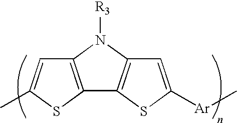

### Formula III,

wherein Ar in Formula III can be a non-DTP moiety as described further below including a moiety that comprises an aromatic unit.

The degree of polymerization n is not particularly limited but can be for example 2 to 500,000 or 5 to 100,000 or 10 to 10,000, or 10 to 1,000, or 10 to 100. In many cases, polymer molecular weight is suitable to allow for solubility.

### Non-DTP Moiety

The non-DTP moiety can comprise one or more ring structures including, for example, one or more aromatic rings, heterocyclic rings, heteroaryl rings, heterocyclic rings, fused rings, thiophene rings, substituted aromatic rings, and/or substituted thiophene rings, wherein the structures including linking sites to the copolymer chain. The non-DTP moiety can comprise conjugated bonds and can function as an acceptor moiety.

Examples include any of the following; the linking bonds to the copolymer chain are shown for monomers 3 and 4 only:

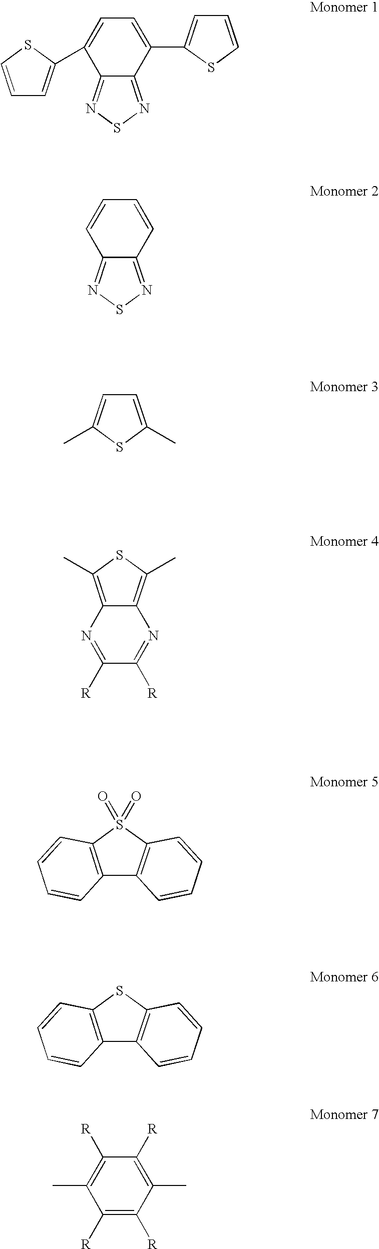

In monomer 4, the R groups can be independently the same structures as described above for R1, R2, and R3. In monomer 7, the R groups can be one of the halogens, such as fluorine. All R groups can be fluorine. Monomers 1-6 can be further substituted as desired. In monomer 5, R can be, for example, a group as describe above for R1, R2, and/or R3.

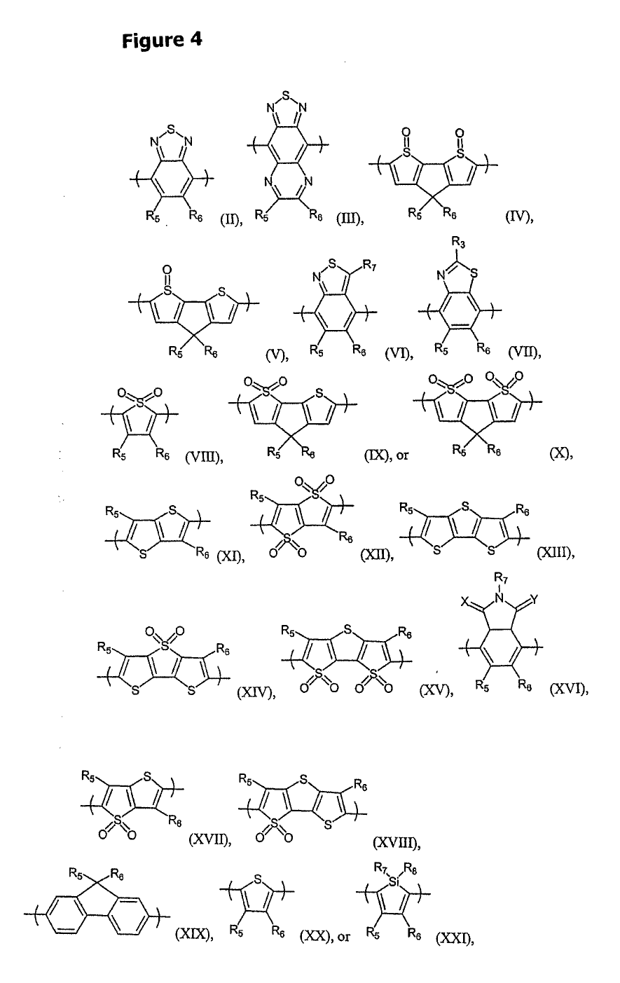

Other non-DTP moieties are described in, for example, WO 2007/011739 (see structures XI, XII, XIII, XIV, XV, or XVI), which is hereby incorporated by reference in its entirety. See also structures in FIG. 4. The various R groups shown in FIG. 4 including R5, R6, R7, and R8 can be independently as described above for R1, R2, and R3.

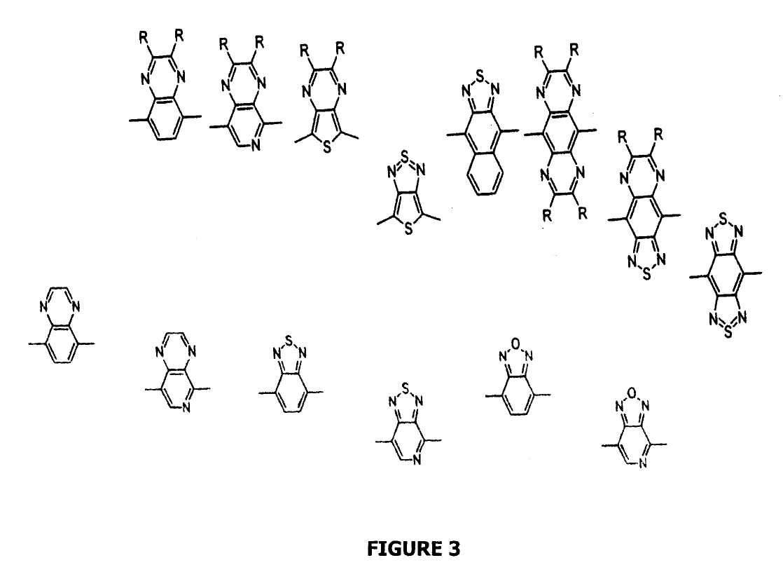

Another example for the non-DTP moiety can be represented by T-X-T wherein T represents a heterocyclic group such as, for example, a thiophene moiety which is covalently linked to an X group, and X can be a variety of groups including, for example, one or more aromatic groups, or heterocyclic groups, or bicyclic groups. Examples of X are shown in FIG. 3. See also, for example, Blouin et al., J. Am. Chem. Soc., 2008, 130, 732-742, which is hereby incorporated by reference in its entirety. In the following representation, the T unit is a thiophene, including a substituted thiophene, and the X unit is a heterocyclic or aromatic moiety. The substituted thiophene can have solubilizing substituents such as, for example, alkyl. Ar can be a moiety as shown in FIG. 3, wherein the various R groups shown in FIG. 3 can be independently as described above for R1, R2, and R3.

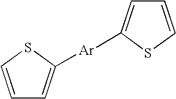

Another example can be represented as:

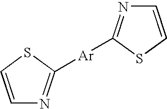

Again, Ar can be a moiety as shown in FIG. 3. Ar can be also, for example, a halogenated aromatic.

Representative structures with use of monomer 2, a thiadiazole, are shown below, including random and alternating copolymers:

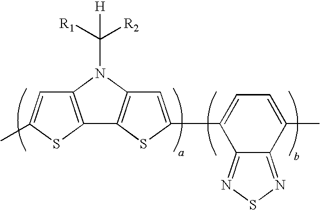

### Formula IV.

In Formula IV, “a” represents the number of repeat units for the DTP structure, and “b” represents the number of repeat units for the non-DTP structure. The ratio of “a” and “b” can be varied by one skilled in the art.

In one embodiment of the invention, one n-type monomer moiety and one p-type monomer moiety can be coupled to form a dimer, which can be represented by

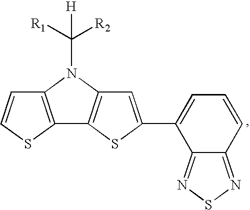

which can be copolymerized to form an alternative copolymer, which can be represented by

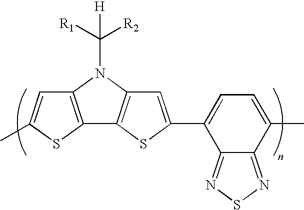

wherein n is the number of repeat units in the alternating copolymer chain.

### Monomer Synthesis

Organic synthesis and polymer chemistry can be used to prepare monomers and polymers. See, for example, March's Advanced Organic Chemistry, Reactions, Mechanisms, and Structure, 6^{th} Ed, 2007. Also, synthetic strategies for preparing monomers and copolymers are described in, for example, Bundgaard et al., “Low Band Gap Polymers for Organic Photovoltaics,” Solar Energy Materials and Solar Cells, 91 (2007), 954-985, and references cited therein.

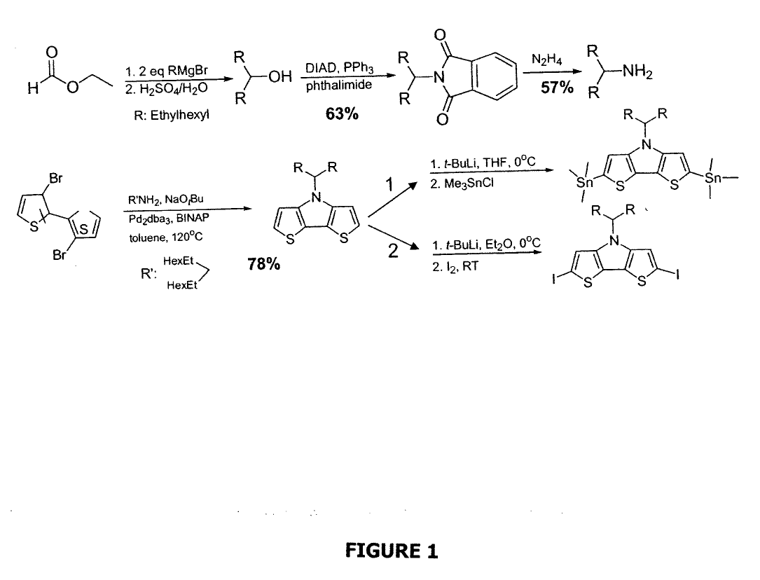

In particular, known organic synthetic methods can be used to prepare monomers, including both DTP monomers and non-DTP monomers; see for example Koeckelberghs et al., Macromolecules, 2007, 40, page 4173, which is hereby incorporated by reference in its entirety. In one embodiment, for example, the p-type monomer moiety can be formed by the reaction scheme depicted in FIG. 1. The moiety can be formed by combining one N-containing compound with one thiophene derivative.

The monomers can be adapted with linking functional groups, generating nucleophilic and electrophilic sites, for polymerization as shown in FIG. 1, including, for example, halogen groups or tin groups.

In another embodiment, monomers can be prepared which comprise fluorinated phenylene moieties. For example, the synthesis of the oligothiophenes bearing, for example, a central tetrafluorophenylene unit and their dibromo derivatives is described in the literature (Crouch, D. J. et al., Chem. Mater. 2005, 17, 6567-6578). In addition, corresponding copolymers of, for example, 4-[3-ethyl-1-(2-ethyl-hexyl)-heptyl]-4H-dithieno[3,2-b;2′,3′-d]pyrrole (DTP) and oligothiophenes with incorporated fluorinated phenylene units can be prepared by Stille coupling methodology utilizing literature references cited herein and procedure below.

Other embodiments comprising DTP and acceptor moiety DTBT are described in Zhou et al., Macromolecules, 2008, 41, 8302-8305, including embodiments for copolymers and monomers.

Examples for preparing copolymers by organic synthesis are known. See, for example, Blouin et al., J. Am. Chem. Soc., 2008, 130, 732-742.

### Copolymerization Reaction

Known polymerization and copolymerization methods can be used including those that form aromatic to aromatic carbon-carbon bonds including thiophene-to-thiophene bonding as known in the art. For example, a plurality of monomers can be copolymerized including, for example, at least two monomers or at least three monomers. Alternatively, one monomer moiety can be combined with another monomer moiety to form a dimer, which then can be polymerized to form an alternating copolymer.

Polymerization reactions are known in the art including, for example, electrochemical or oxidative chemical polymerization, or metal promoted cross-coupling polymerizations, e.g., Stille coupling ((a) Stille, J. K. Angew. Chem. Int. Ed. Engl. 1986, 25, 508. (b) Farina, V. et al. J. Am. Chem. Soc. 1991, 113, 9585. (b) Bao, Z. et al. J. Am. Chem. Soc. 1995, 117, 12426.), and Yamamoto-type polymerization (Yamamoto, T. et al. Macromolecules 1992, 25, 1214.).

Another example of polymerization is the Grignard Metathesis (GRIM) method, which is generally known in the art. For a more detailed description of this method, see, for example, Lowe, R. S. et al., Adv. Mater., 1999, 11, page 250; Iovu, M. C. et al., Macromolecules 2005, 38, 8649; Yokoyama et al., Macromolecules, 2004, 37, page 1169, which hereby are incorporated by reference in their entirety.

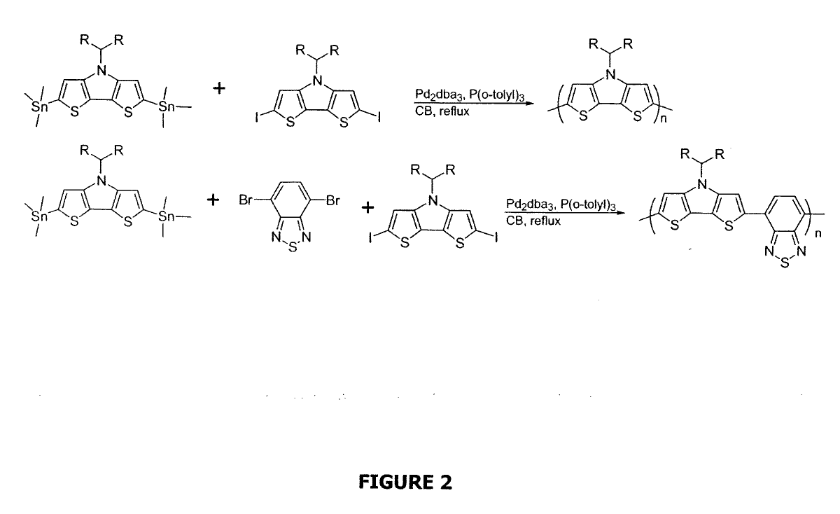

FIG. 2 illustrates additional examples of polymerization and copolymerization embodiments including use of Stille coupling. For a more detailed description of such copolymerization methods, see, for example. Liu, J. et al., J. Am. Chem. Soc., 2008, 130, page 13167, which hereby is incorporated by reference in its entirety.

### Properties

One important property is resistance to oxidation in the air. For example, resistance to oxidation in air can be measured spectroscopically and resistance can extend over, for example, at least 24 hours, or at least 48 hours, or at least one week, or at least one month. Ambient air can be used in which normal oxygen content is present in the air. Ambient room temperature can be used. If desired, more acute testing conditions can be used such as, for example, elevated temperatures or elevated oxygen contents.

Combinations of properties can be also important such as, for example, good resistance to oxidation in air combined with, for example, good processability and/or low band gap, as well as other properties noted herein with respect to advantages and performance.

### Applications

The polymers and copolymers described herein can be used in organic electronic devices including, for example, OLEDs, OPVs including as OPV active layer, transistors, OFETs, batteries, and printed electronics generally, as well as sensors.

Printed Electronics are generally known in the art. See, for example, Printed Organic and Molecular Electronics, Ed. D. Gamota et al., 2004. For example, Chapters 1 and 2 describe organic semiconductors, Chapter 3 describes manufacturing platforms for printing circuits, Chapter 4 describes electrical behavior of transistors and circuits, Chapter 5 describes applications, and Chapter 6 describes molecular electronics. See also Pope et al., Electronic Processes in Organic Crystals and Polymers, 1999.

Photovoltaic cells are known in the art. See, for example, Sun and Sariciftci, Organic Photovoltaics, Mechanisms, Materials, and Devices, 2005. See, also, for example, US Patent Publication 2008/0315751 published Dec. 25, 2008 to Sheina et al. The photovoltaic cell can comprise an active layer comprising a composition comprising at least one p-type material and at least one n-type material. One can engineer HOMO, LUMO, and band gaps for the p- and n-type materials for good performance. The morphology of the active layer can be adapted to provide good performance. For example, a nanoscale morphology can be prepared. An example is a bulk heterojunction.

In an OPV active layer, the polymers described herein, which can be p-type materials, can be combined with n-type materials or acceptor moieties, such as, for example, fullerenes and fullerene derivatives. An example of a fullerene derivative is PCBM. Fullerenes can be also derivatized with a moiety such as indene or substituted indene. One fullerene core can be derivatized with, for example, one, two, or three indene groups. Other types of n-type materials known in the art can be used. If desired, larger area photovoltaics can be fabricated. See, for example, Bundgaard et al., Solar Energy Materials and Solar Cells, 2007, 91, 1019-1025.

One reference teaches employing substituted thiophenes as comonomers which has resulted in improvements in such properties as solubility and molecular weight. See Liu et al., J. Am. Chem. Soc., 2008, 130, 13167-13176. Measurement of resistance to oxidation can be an important embodiment. For example, one method of measuring instability towards oxidation is through the use of UV-visible absorption spectrophotometric methods, where progressive oxidation can result in the development of new absorption peaks and either the bathochromic/hypsochromic or hyperchromic/hypochromic (e.g., left/right, also referred as to red/blue or up/down, respectively) shifting of the spectrum. See, for example, Ogawa et al., Macromolecules, 2006, 39, 1771-1778. Embodiments which provide improved resistance to oxidation are in many cases preferred.

### EXAMPLES AND WORKING EXAMPLES

Additional embodiments are provided in the following non-limiting examples and working examples.

The following synthetic examples are illustrative and not intended to be limiting. Unless specified, all reactions were conducted under prepurified nitrogen or argon, using oven-dried glassware. Ice/water, dry ice/acetone were used for 0° and −78° C. baths, respectively. Commercial chemicals were purchased from Aldrich Chemical Co., Inc. and used without further purification. Prior to use, tetrahydrofuran (THF) and diisopropylamine were dried over and distilled from sodium benzophenone ketyl and calcium hydride, respectively. Titration of the Grignard/organolithium reagents was performed following the procedure described by Love, B. E. et al. J. Org. Chem. 1999, 64, 3755.

Synthesis of 4-[3-ethyl-1-(2-ethyl-hexyl)-heptyl]-4H-dithieno[3,2-b;2′,3′-d]pyrrole was adapted from Koeckelberghs, G. et al. Macromolecules 2007, 40, 4173. The synthesis of 4,7-dibromo-benzo[1,2,5]thiadiazole was described in the literature (Hou, Q. et al. Mater. Chem. 2002, 10, 2887).

### Example 1

### Synthesis of 5,9-diethyl-tridecan-7-ol

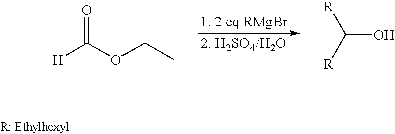

A dry 2-L three-neck round bottom flask equipped with a condenser, an addition funnel, stir bar and a nitrogen outlet was charged with a 1 M solution of ethylhexylmagnesium bromide in diethyl ether (Et₂O) (600 mL, 0.30 mol). A 6 M solution of ethyl formate (22 g, 0.30 mol) in anhydrous Et₂O was added dropwise to the reaction flask via addition funnel at a rate to maintain a gentle reflux. After addition was completed, stirring was continued for another 15 minutes followed by addition of water (42 mL) at a rate that rapid reflux occurred. This was followed by addition of a 90:10 vv % mixture of concentrated sulfuric acid (18 mL) in H₂O (162 mL). The solids were filtered off and thoroughly rinsed with Et₂O. The organic layer was washed three times with a saturated solution of NaHCO₃ and brine. The combined organic layers were dried over anhydrous magnesium sulfate (MgSO₄). After solution was filtered, solvent was removed by rotary evaporation, and the crude product was purified using a column chromatography on silica gel with hexanes as the eluent. The purity was checked by NMR and GC/MS analysis. Compound was isolated as colorless oil and yields range between 70 and 80%.

Spectral data: ¹H NMR (300 MHz, CDCl₃): δ_{H} 3.75 (m, 1H), 1.5-1.2 (m, 23H), 0.9-0.8 (m, 12H), 2.51 (d, J=7 Hz, 2H), 7.12 (m, 5H). ¹³C NMR (300 MHz, CDCl₃): δ_{C} 67.8, 42.4, 35.5, 35.3, 33.3, 32.6, 32.2, 28.8, 28.6, 26.5, 25.6, 23.1, 23.0, 14.1, 13.9, 10.8, 10.4.

### Example 2

### Synthesis of 2-[3-ethyl-1-(2-ethyl-hexyl)-heptyl]-isoindole-1,3-dione

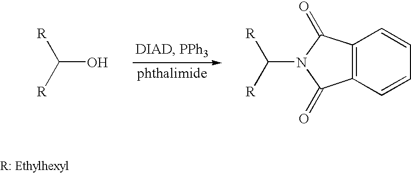

A dry 500-mL three-neck round bottom flask equipped with a stir bar and a nitrogen outlet was charged with triphenylphosphine (57.4 g, 0.219 mol), phthalimide (32.2 g, 0.219 mol), 5,9-diethyl-tridecan-7-ol (56.1 g, 0.219 mol), and was flashed with N₂. Dry diethyl ether (250 mL) was added to the reaction flask via cannula. A 2.5 M solution of diisopropyl azodicarboxylate (DIAD) (44.3 g, 0.219 mol) in dry diethyl ether was added dropwise. After stirring for 12 hours at ambient temperature, the precipitate was filtered off and washed thoroughly with diethyl ether. After solvent was removed by rotary evaporation, and the crude product was purified using a column chromatography on silica gel with 5:5 hexanes/methylene chloride as the eluent. The purity was checked by NMR and GC/MS analysis. Compound was isolated as colorless oil and yields ranged between 60 and 70%.

Spectral data: ¹H NMR (300 MHz, CDCl₃): δ_{H} 7.8 (m, 2H), 7.7 (m, 2H), 4.4 (m, 1H), 2.1 (m, 2H), 1.6-1 (m, 20H), 0.9-0.8 (m, 12H). ¹³C NMR (300 MHz, CDCl₃): δ_{C} 168.8, 133.7, 131.9, 122.9, 48.0, 36.6, 36.5, 36.1, 35.9, 32.8, 32.2, 28.7, 28.3, 26.0, 25.3, 23.0, 22.9, 14.1, 13.9, 10.8, 10.2.

### Example 3

### Synthesis of 3-ethyl-1-(2-ethyl-hexyl)-heptylamine

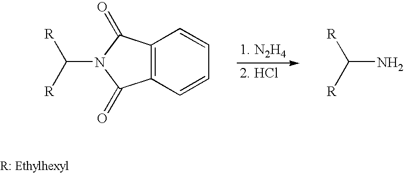

A dry 250-mL three-neck round bottom flask equipped with a condenser, a stir bar, and a nitrogen outlet was charged with 2-[3-ethyl-1-(2-ethyl-hexyl)-heptyl]-isoindole-1,3-dione (11.8 g, 0.31 mmol), anhydrous methanol (100 mL) via syringe, and was flashed with N₂. An excess of hydrazine monohydrate solution (65%) (7 mL) was added to the reaction flask dropwise. The reaction mixture was heated to reflux and conversion of starting material to amine was monitored by GC analysis (if conversion was not completed after 2 hours another portion of hydrazine monohydrate was added dropwise. After conversion was complete, excess of HCl solution (5 M) was added and the reaction mixture was kept at reflux for additional 15 minutes. An excess of NaOH solution (2 M) was added and the crude product was extracted three times with diethyl ether. The combined organic layers were dried over anhydrous magnesium sulfate (MgSO₄). After solution was filtered, solvent was removed by rotary evaporation, and the crude product was purified via vacuum distillation. Compound was isolated as colorless oil and yields ranged between 50 and 60%. The purity was checked by NMR and GC/MS analysis.

Spectral data: ¹H NMR (300 MHz, CDCl₃): δ_{H} 2.8 (m, 1H), 1.4-1.2 (m, 24H), 0.9-0.8 (m, 12H). ¹³C NMR (300 MHz, CDCl₃): δ_{C} 46.3, 43.2, 43.1, 35.6, 35.4, 33.3, 32.5, 28.8, 28.4, 26.6, 25.5, 23.2, 23.1, 23.0, 14.0, 10.8, 10.3.

### Example 4

### Synthesis of 3,3′-dibromo-[2,2′]bithiophenyl

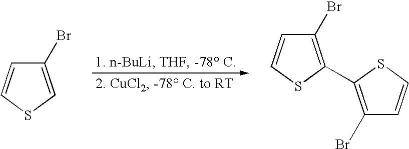

A dry 100-mL three-neck flask was flushed with N₂ and was charged with diisopropylamine (16.4 mL, 0.117 mol) and THF (195 mL, 0.6 M) via deoxygenated syringe. The reaction flask was cooled to 0° C. and a 2.5 M solution of n-butyllithium in hexanes (40.4 mL, 0.101 mol) was added dropwise via deoxygenated syringe. After 30 minutes of stirring at 0° C., the solution was chilled to −76° C. (acetone/dry ice bath) and stirring was continued for 5 minutes. To this reaction mixture a previously chilled to −76° C. 0.2 M solution of 3-bromothiophene (16.3 g, 0.10 mol) in anhydrous THF was added dropwise via cannula such that temperature does not exceed −50° C. The reaction mixture was stirred for 10 minutes at −76° C., then stirring was continued for 30 minutes at 0° C., and the reaction mixture was chilled back to −76° C. Anhydrous CuCl₂ (26.9 g, 0.20 mol) was added to the reaction flask in one portion and stirring continued for 1 hour at −76° C. The cooling bath was removed and the reaction mixture was allowed to warm to ambient temperature. A GC-MS sample was taken from the reaction flask in 1 hour to monitor conversion of 3-bromothiophene to 3,3′-dibromo-2,2′-bithiophene. As the conversion was completed, the solvent was removed by rotary evaporation. Aqueous solution of HCl (10%) was added to the flask to dissolve copper salts. The aqueous layer was separated and extracted with chloroform. The combined organic phase was collected, dried over anhydrous magnesium sulfate (MgSO₄). After the product was filtered, the solvent was removed by rotary evaporation. The crude product was purified by recrystallization from ethanol and/or sublimation to yield white crystalline solid. Obtained yields ranged from 60 to 70%. The purity was checked by NMR and GC/MS analysis.

Spectral data: ¹H NMR (300 MHz, CDCl₃): δ_{H} 7.4 (d, 2H), 7.1 (d, 2H). ¹³C NMR (300 MHz, CDCl₃): δ_{C} 130.8, 128.9, 127.5, 112.7.

### Example 5

### Synthesis of 4-[3-ethyl-1-(2-ethyl-hexyl)-heptyl]-4H-dithieno[3,2-b;2′,3′-d]pyrrole

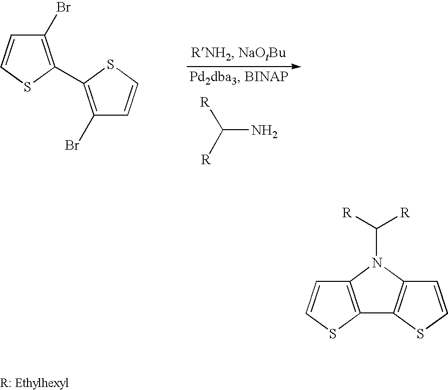

A dry 100-mL three-neck flask equipped with a condenser, a stir bar, and a nitrogen outlet was charged with sodium tert-butoxide (NaOtBu) (3.22 g, 33.6 mmol), 2,2′-bis(diphenylphosphino)-1,1′-binaphthyl (BINAP) (0.872 g, 1.40 mmol), tris(dibenzylideneacetone)dipalladium (0) (Pd₂ dba₃) (0.320 g, 0.350 mmol), and 3,3′-dibromo-[2,2′]bithiophenyl (4.54 g, 14.0 mmol) in a glove box. The flask was removed from the glove box and charged with anhydrous toluene (35 mL) that has been previously deoxygenated by purging the solvent with nitrogen for at least 15 to 30 minutes. The solvent was introduced via deoxygenated syringe, followed by addition of 3-ethyl-1-(2-ethyl-hexyl)-heptylamine (3.58 g, 14.0 mmol) also via syringe. The solution mixture was stirred at 125° C. under inert atmosphere until completion of the reaction that takes about 12 hours and was monitored by GC/MS analysis. If the conversion was incomplete, a second portion of BINAP, NaOtBu, and Pd₂ dba₃ was added to the reaction flask and the reaction was allowed to proceed for additional 12 hours. Upon completion, the reaction was cooled down to ambient temperature and quenched with water. The layers were separated and the aqueous layer was extracted three times with diethyl ether, the organic layers collected, and were dried over MgSO₄. After the product was filtered, the solvent was removed by rotary evaporation. The crude product was purified by column chromatography on silica gel with hexanes as the eluent. The purity was checked by NMR and GC/MS analysis. Compound was isolated as yellow oil and yields range between 70 and 80%.

Spectral data: ¹H NMR (300 MHz, CDCl₃): δ_{H} 7.1 (d, 2H), 7.0 (br, 2H), 4.5 (m, 1H), 2.0 (m, 2H), 1.6 (m, 2H), 1.4-0.6 (m, 30H).

### Example 6

### Synthesis of 4-[3-ethyl-1-(2-ethyl-hexyl)-heptyl]-2,6-bis-trimethylstannanyl-4H-dithieno[3,2-b;2′,3′-d]pyrrole

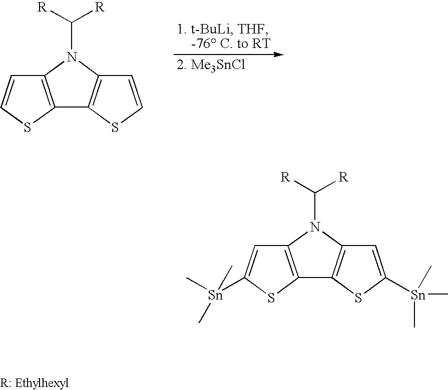

A dry 100-mL three-neck flask equipped with a stir bar, and a nitrogen outlet is charged with 4-[3-ethyl-1-(2-ethyl-hexyl)-heptyl]-4H-dithieno[3,2-b;2′,3′-d]pyrrole (0.887 g, 2.10 mmol) and purged with nitrogen. Anhydrous diethyl ether (105 mL) is added to the flask via cannula. The reaction flask is cooled to −76° C. (acetone/dry ice bath) and a 1.7 M solution of tert-butyllithium in pentane (2.6 mL, 4.41 mmol) is added dropwise via deoxygenated syringe. After 30 minutes of stirring at −76° C., the ice bath is removed and stirring is continued for another hour at ambient temperature. The reaction mixture is chilled again to −76° C. and a solution of Me₃SnCl (0.963 g, 4.83 mmol) in anhydrous diethyl ether (0.3 M) is added dropwise via syringe. The ice bath is removed and stirring is continued for two more hours at ambient temperature. The reaction mixture is concentrated in vacuo and the crude compound is dissolved in hexanes and the precipitate is filtered off. The solvent is removed by rotary evaporation. The purity is checked by NMR and GC/MS analysis and the crude product is used without further purification. Compound is isolated as viscous oil and yields range between 90 and 95%.

Spectral data: ¹H NMR (300 MHz, CDCl₃): δ_{H} 7.07 (d, 1H), 6.9 (br, 1H), 4.45 (m, 1H), 2.06 (m, 2H), 1.6 (m, 2H), 1.4-0.6 (m, 30H), 0.38 (br m, 18H).

### Example 7

### Synthesis of 4-[3-ethyl-1-(2-ethyl-hexyl)-heptyl]-2,6-diiodo-4H-dithieno[3,2-b;2′,3′-d]pyrrole

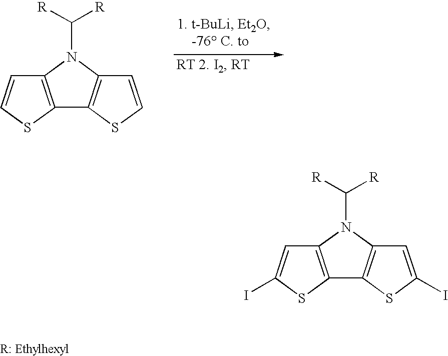

A dry 100-mL three-neck flask equipped with a stir bar, and a nitrogen outlet was charged with 4-[3-ethyl-1-(2-ethyl-hexyl)-heptyl]-4H-dithieno[3,2-b;2′,3′-d]pyrrole (0.887 g, 2.10 mmol) and purged with nitrogen. Anhydrous diethyl ether (105 mL) was added to the flask via cannula. The reaction flask was cooled to −76° C. (acetone/dry ice bath) and a 1.7 M solution of tert-butyllithium in pentane (2.6 mL, 4.41 mmol) was added dropwise via deoxygenated syringe. After 30 minutes of stirring at −76° C., the ice bath was removed and stirring was continued for another hour at ambient temperature. The reaction mixture was chilled again to −76° C. and a 0.5 M solution of 12 (1.35 g, 5.31 mmol) in anhydrous diethyl ether (11 μL) was added dropwise via syringe. The ice bath was removed and stirring was continued for two more hours at ambient temperature. The reaction mixture was transferred to a separation funnel and was washed in sequence with a Na₂S₂O₃ solution, a NaHCO₃ solution, and brine. The organic layer was dried over MgSO₄. After the product was filtered, the solvent was removed by rotary evaporation. The crude product was purified by column chromatography on silica gel with 9:1 hexanes:methylene chloride as the eluent. Compound was isolated as yellow oil and yields ranged between 70 and 80%. The purity was checked by NMR and GC/MS analysis.

### Example 8

### General procedure for synthesis of poly{4-[3-ethyl-1-(2-ethyl-hexyl)-heptyl]-4H-dithieno[3,2-b;2′,3′-d]pyrrole} via Stille-type polymerization

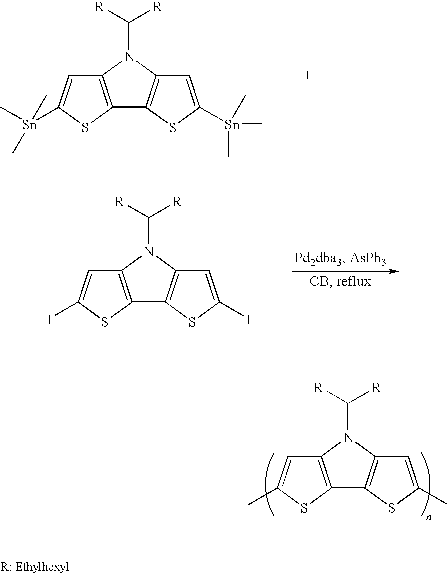

A dry 100-mL three-neck flask equipped with a condenser, a stir bar, and a nitrogen outlet is charged with 4-[3-ethyl-1-(2-ethyl-hexyl)-heptyl]-2,6-bis-trimethylstannanyl-4H-dithieno[3,2-b;2′,3′-d]pyrrole (1.00 mmol), 4-[3-ethyl-1-(2-ethyl-hexyl)-heptyl]-2,6-diiodo-4H-dithieno[3,2-b;2′,3′-d]pyrrole (1.00 mmol), Pd₂ dba₃ (22.9 mg, 2.5 mol %), and AsPh₃ (61.2 mg, 0.200 mmol) in a glove box. The flask is removed from the glove box and charged with anhydrous chlorobenzene (35 mL) that has been previously deoxygenated by purging the solvent with nitrogen for at least 30 minutes. The reaction mixture is subjected to gentle reflux for 72 hours. After cooling, the polymer is precipitated in methanol, filtered and purified by Soxhlet extractions utilizing successively methanol, acetone, hexanes, and chloroform. Hexanes and chloroform fractions are concentrated, re-precipitated in methanol, isolated via filtration, and analyzed by gel permeation chromatography (GPC) and NMR.

### Example 9

### General procedure for synthesis of copoly{2-benzo[1,2,5]thiadiazol-alt-4-yl-4-[3-ethyl-1-(2-ethyl-hexyl)-heptyl]-4H-dithieno[3,2-b;2′,3′-d]pyrrole}

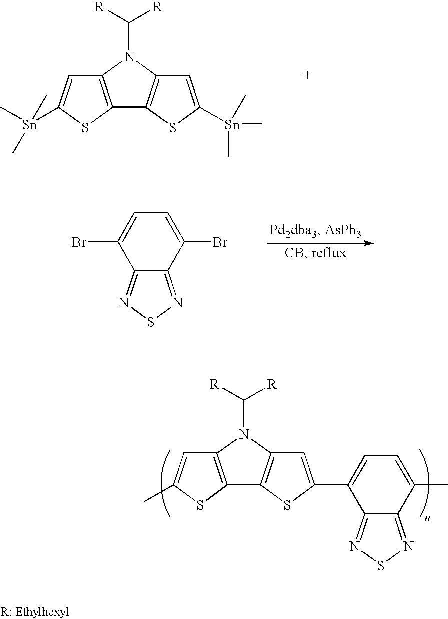

A dry 100-mL three-neck flask equipped with a condenser, a stir bar, and a nitrogen outlet is charged with 4-[3-ethyl-1-(2-ethyl-hexyl)-heptyl]-2,6-bis-trimethylstannanyl-4H-dithieno[3,2-b;2′,3′-d]pyrrole (1.00 mmol), 4,7-dibromo-benzo[1,2,5]thiadiazole (1.00 mmol), Pd₂ dba₃ (22.9 mg, 2.5 mol %), and AsPh₃ (61.2 mg, 0.200 mmol) in a glove box. The flask is removed from the glove box and charged with anhydrous chlorobenzene (35 mL) that has been previously deoxygenated by purging the solvent with nitrogen for at least 30 minutes. The reaction mixture is subjected to gentle reflux for 72 hours. After cooling, the polymer is precipitated in methanol, filtered and purified by Soxhlet extractions utilizing successively methanol, acetone, hexanes, and chloroform. Hexanes and chloroform fractions are concentrated, re-precipitated in methanol, isolated via filtration, and analyzed by gel permeation chromatography (GPC) and NMR.

### Example 10

### General procedure for synthesis of copoly{N-[1(2′-ethylhexyl)-3-ethylheptanyl]dithieno[3,2-b;2′,3′-d]pyrrole-2,6-diyl-alt-4,7-di(2-thienyl)-2,1,3-benzothiadiazole-5′,5″-diyl}

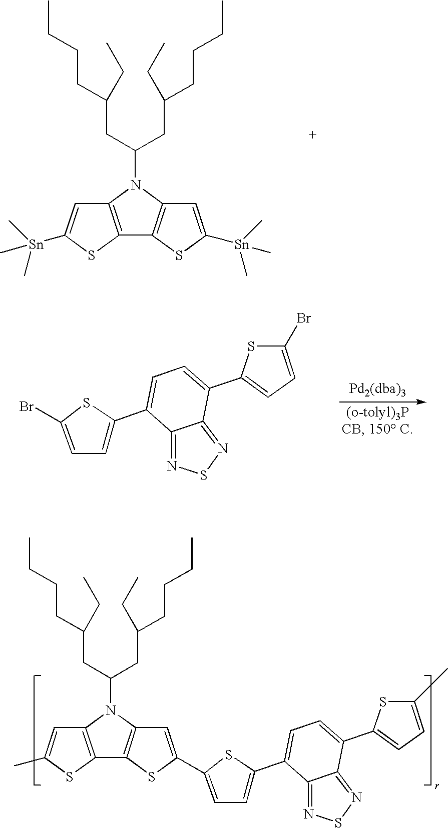

A dry 100-mL three-neck flask equipped with a condenser, a stir bar, and a nitrogen outlet was charged with 4-[3-ethyl-1-(2-ethyl-hexyl)-heptyl]-2,6-bis-trimethylstannanyl-4H-dithieno[3,2-b;2′,3′-d]pyrrole (1.20 mmol), 4,7-bis(5-bromo-2-thienyl)-2,1,3-benzothiadiazole (1.20 mmol), Pd₂dba₃ (22.2 mg, 2.0 mol %), and (o-tolyl)₃P (59.0 mg, 16 mol %) in a glove box. The flask was removed from the glove box and charged with anhydrous chlorobenzene (40 mL) that had been previously deoxygenated by purging the solvent with nitrogen for at least 30 minutes. The reaction mixture was subjected to gentle reflux for 15 hours. After cooling, the polymer was precipitated in methanol, filtered and purified by Soxhlet extractions utilizing successively methanol, acetone, hexanes, and chloroform. Hexanes and chloroform fractions were concentrated, re-precipitated in methanol, isolated via filtration, and analyzed by gel permeation chromatography (GPC) and NMR. GPC: Mₙ=2,190, PDI: 1.5.

Spectral data: ¹H NMR (500 MHz, CDCl₃): δ_{H}8.2-6.6 (m, 8H), 4.5 (br, 1H), 2.1-0.5 (m, 34H). Polymer obtained was called PDTPDTBT-I and PDTPDTBT-II.

TABLE 1

| | | | λₘₐₓ | λₘₐₓ | | |
|---|---|---|---|---|---|---|
| p-Type | | | nm | nm | Eg^{UV} | Method of |
| polymer | Mw | PDI | (CHCl₃) | (film) | eV | Synthesis |
| PDTPDTBT-I | 2,710 | 1.3 | 618 | 647 | 1.5 | Stille |
| PDTPDTBT-II | 3,160 | 1.4 | 616 | 646 | 1.6 | Stille |

Samples of the polymers of Table 1 were tested for resistance to oxidation in the presence of air using UV-Visible absorption spectroscopy, as polymer solutions in chloroform, as solid-state films spin cast from chlorobenzene in air, and as solid-state films annealed in air at 110° C. for 30 minutes. All of the spectra lacked development of low-energy absorptions that would be indicative of polymer oxidation.

### Example 11

### General procedure for synthesis of copolymers of 4-[3-ethyl-1-(2-ethyl-hexyl)-heptyl]-4H-dithieno[3,2-b;2′,3′-d]pyrrole (DTP) and oligothiophenes with incorporated fluorinated phenylene units

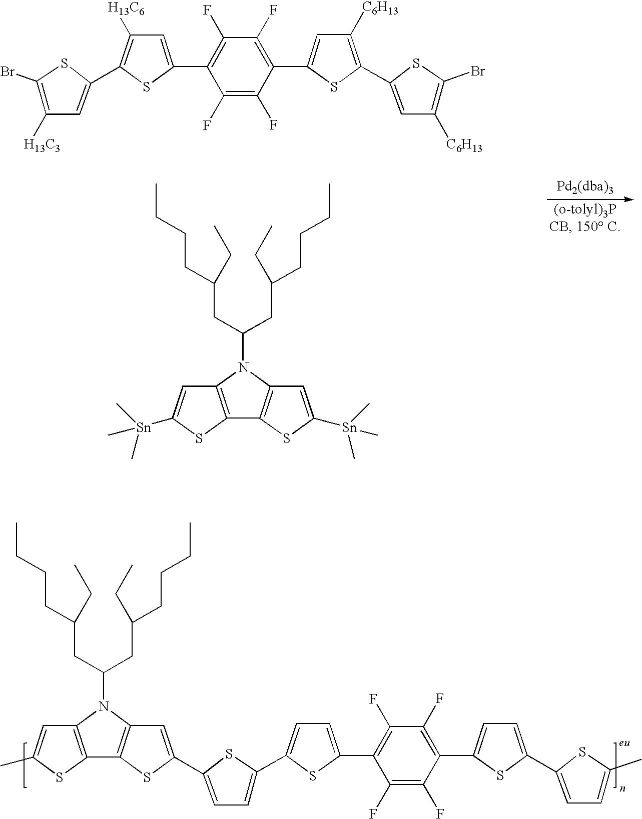

A dry 100-mL three-neck flask equipped with a condenser, a stir bar, and a nitrogen outlet is charged with 4-[3-ethyl-1-(2-ethyl-hexyl)-heptyl]-2,6-bis-trimethylstannanyl-4H-dithieno[3,2-b;2′,3′-d]pyrrole (1.20 mmol), 2-bromo-5-[5-[4-[5-(5-bromo-4-methyl-2-thienyl)-4-methyl-2-thienyl]-2,3,5,6-tetrafluoro-phenyl]-3-methyl-2-thienyl]-3-methyl-thiophene (1.20 mmol), Pd₂dba₃ (22.2 mg, 2.0 mol %), and (o-tolyl)₃P (59.0 mg, 16 mol %) in a glove box. The flask is removed from the glove box and charged with anhydrous chlorobenzene (40 mL) that had been previously deoxygenated by purging the solvent with nitrogen for at least 30 minutes. The reaction mixture is subjected to gentle reflux for 15 to 24 hours. After cooling, the polymer is precipitated in methanol, filtered and purified by Soxhlet extractions utilizing successively methanol, acetone, hexanes, and chloroform. Chloroform fractions are concentrated, re-precipitated in methanol, isolated via filtration, and analyzed by gel permeation chromatography (GPC) and NMR.

### Testing:

TABLE 1

| | | | λₘₐₓ | λₘₐₓ | | |
|---|---|---|---|---|---|---|
| p-Type | | | nm | nm | Eg^{UV} | Method of |
| polymer | Mw | PDI | (CHCl₃) | (film) | eV | Synthesis |
| PDTPDTBT-I | 2,710 | 1.3 | 618 | 647 | 1.5 | Stille |
| PDTPDTBT-II | 3,160 | 1.4 | 616 | 646 | 1.6 | Stille |

Samples of the polymers of Table 1 (both obtained via Example 10) were tested for environmental oxidative stability towards ambient conditions using UV-Visible absorption spectroscopy, as polymer solutions in chloroform, as solid-state films spin cast from chlorobenzene in air, and as solid-state films annealed in air at 110° C. for 30 minutes. Spectra lacked development of low-energy absorptions that would be indicative of polymer oxidation.

### Example 12

### Fabrication of an Organic Photovoltaic Cell from a Polymer

Photovoltaic devices were prepared comprising (i) patterned indium tin oxide (ITO, anode, 60Ω/square) on glass substrates purchased from Thin Film Devices) located in Anaheim, Calif.), (ii) a thin layer of HIL (30 m thick) comprising PEDOT/PSS (AI 4083) purchased from HC Stark; (iii) either a 100- to 200-nm layer of PDTPDTBT-I or PDTPDTBT-II (as prepared via the Stille method described in Example 10) blended with the n-type, which is either methanofullerence [6,6]-phenyl C61-butyric acid methyl ester (PCBM) (purchased from Nano-C, located in Westwood, Mass.) or C₆₀-indene bis-adduct (prepared according to the procedure of U.S. application Ser. No. 12/340,587); and (iv) a Ca/Al bilayer cathode.

The patterned ITO glass substrates were cleaned with detergent, hot water, and organic solvents (acetone and alcohol) in an ultrasonic bath and treated with ozone plasma immediately prior to device layer deposition. The HIL solution (Baytron AI 4083) was then spin-coated onto the patterned ITO glass substrate to achieve a thickness of 30 nm. The film was dried at 150° C. for 30 minutes in a nitrogen atmosphere. The active layer was formulated to either a 1:1 or 1.5:1 weight ratio polymer:n-type blend in chlorobenzene. The formulation was made to 0.024% volume solids and was then spun onto the top of the HIL film, resulting in no damage to the HIL (as verified by AFM).

The film was then annealed in the range of 175° C. for 30 minutes in a glove box. Next, a 5-nm Ca layer was thermally evaporated onto the active layer through a shadow mask, followed by deposition of a 150-nm Al layer. The devices were then encapsulated via a glass cover slip (blanket). Encapsulation was sealed with EPO-TEK OG112-4 UV curable glue. The encapsulated device was cured under UV irradiation (80 mW/cm²) for 4 minutes and tested as follows.

The photovoltaic characteristics of devices under white light exposure (Air Mass 1.5 Global Filter) were measured using a system equipped with a Keithley 2400 source meter and an Oriel 300W Solar Simulator based on a Xe lamp with output intensity of 100 mW/cm² (AM1.5G). The light intensity was set using an NREL-certified Si—KG5 silicon photodiode.

The short circuit current density J_{sc}, the open circuit photovoltage V_{oc}, and the power conversion efficiency η were measured of each OPV device and of a control device made using poly(3-hexylthiophene) as the p-type and PCBM (purchased from Nano-C, located in Westwood, Mass.) as the n-type materials. The regioregular poly(3-hexylthiophene) was prepared via the GRIM route from 2,5-dibromo-3-hexylthiophene. (See Lowe, R. S. et al., Adv. Mater. 1999, 11, 250 and Iovu, M. C. et al., Macromolecules 2005, 38, 8649.) The efficiencies in Table 2 are averages of measurements taken from four pixels on each device. The “best η” column represents the best efficiencies seen among the four pixel measurements on each device.

The data in Table 2 show a significant improvement in the V_{oc} for the OPV cell made with PDTPDTBT-I and Indene-bis-C60 compared to the OPV cells made with PDTPDTBT-I and PCBM.

TABLE 2

| | | n-type | | | J_{SC} | | | | V_{OC} |
|---|---|---|---|---|---|---|---|---|---|
| p-type polymer | Mw (PDI)¹ | component | p/n ratio | Solvent² | (mA/cm²) | FF | η (%) | Best η (%) | (V) |
| P3HT | 100,000 (2) | Indene bis- | 1:01 | DCB | 9.10 | 0.62 | 4.74 | 4.92 | 0.85 |
| | | C60 | | | | | | | |
| PDTPDTBT-I | 2,710 (1.3) | PCBM | 1.5:1 | CB | 2.06 | 0.28 | 0.30 | 0.32 | 0.52 |
| PDTPDTBT-I | 2,710 (1.3) | PCBM | 1.5:1 | CB | 1.83 | 0.28 | 0.24 | 0.25 | 0.47 |
| PDTPDTBT-II | 3,160 (1.4) | PCBM | 1.5:1 | CB | 1.56 | 0.27 | 0.22 | 0.23 | 0.52 |
| PDTPDTBT-II | 3,160 (1.4) | PCBM | 1.5:1 | CB | 1.54 | 0.26 | 0.22 | 0.23 | 0.54 |
| PDTPDTBT-I | 2,710 (1.3) | Indene bis- | 1:01 | CB | 1.54 | 0.26 | 0.28 | 0.32 | 0.71 |
| | | C60 | | | | | | | |
| PDTPDTBT-I | 2,710 (1.3) | Indene bis- | 1:01 | CB | 1.43 | 0.26 | 0.29 | 0.30 | 0.78 |
| | | C60 | | | | | | | |
| PDTPDTBT-II | 3,610 (1.4) | Indene bis- | 1:01 | CB | 1.45 | 0.26 | 0.21 | 0.27 | 0.57 |
| | | C60 | | | | | | | |

¹Number average molecular weight and polydispersity index (Mₙ and PDI, respectively) were determined via Gel Permeation Chromatography (GPC) with chloroform as the eluent (flow rate 1.0 mL/min, 35° C., λ = 254 nm) against polystyrene standards with toluene used as an internal standard. Weight-average molecular weight M_{w} was derived from these.
²Solvent: dichlorobenzene (DCB); chlorobenzene (CB)

What is claimed:

1. A composition comprising at least one copolymer, the copolymer comprising at least one first dithieno[3,2-b:2′,3′-d]pyrrole (DTP) repeat unit.

2. A composition according to claim 1, wherein the DTP repeat unit is represented by: 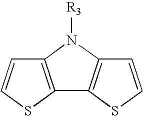
wherein R₃ is an optionally substituted alkyl, an optionally substituted aryl or heteroaryl, an optionally substituted alkenyl, or an optionally substituted alkynyl.

3. A composition according to claim 1, wherein the DTP repeat unit is represented by: 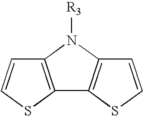
wherein R3 is a protecting group which can be thermally removed.

4. The composition of claim 1, wherein the DTP repeat unit is represented by: 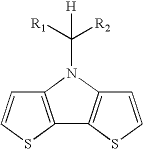
wherein R₁ and R₂ are independently an optionally substituted alkyl, an optionally substituted aryl or heteroaryl, an optionally substituted alkenyl, or an optionally substituted alkynyl.

5. The composition of claim 1, wherein the DTP repeat unit is represented by: 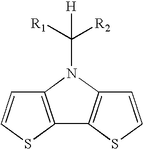
and R₁ and R₂ can be the same or different and are each an optionally substituted alkyl group.

6. The composition of claim 1, wherein the DTP repeat unit is represented by: 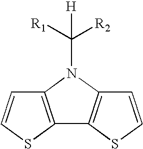
and R₁ and R₂ can be the same or different and are each an optionally substituted branched alkyl group.

7. The composition of claim 6, wherein R₁ and R₂ are both 2-ethylhexyl groups.

8. The composition of claim 1, wherein the copolymer comprises at least two different DTP units.

9. The composition of claim 1, wherein the copolymer is an alternating copolymer comprising at least one DTP repeat unit and at least one non-DTP repeat unit.

10. The composition of claim 1, wherein the copolymer comprises repeating dimer units, wherein each dimer unit comprises a DTP repeat unit and a non-DTP repeat unit.

11. The composition of claim 1, wherein the copolymer comprises repeating dimer units, wherein each dimer unit comprises a DTP repeat unit and a non-DTP repeat unit, the non-DTP unit comprising at least one ring structure.

12. The composition of claim 1, wherein the copolymer comprises repeating dimer units, wherein each dimer unit comprises a DTP repeat unit and a non-DTP repeat unit, the non-DTP unit comprising at least one fused ring structure.

13. The composition of claim 1, wherein the copolymer comprises repeating dimer units, wherein each dimer unit comprises a DTP repeat unit and a non-DTP repeat unit, the non-DTP unit comprising at least one aromatic ring structure.

14. The composition of claim 1, wherein the copolymer comprises repeating dimer units, wherein each dimer unit comprises a DTP repeat unit and a non-DTP repeat unit, the non-DTP unit comprising at least one thiophene ring structure.

15. The composition of claim 1, wherein the copolymer comprises repeating dimer units, wherein each dimer unit comprises a DTP repeat unit and a non-DTP repeat unit which is represented by at least one of the following:

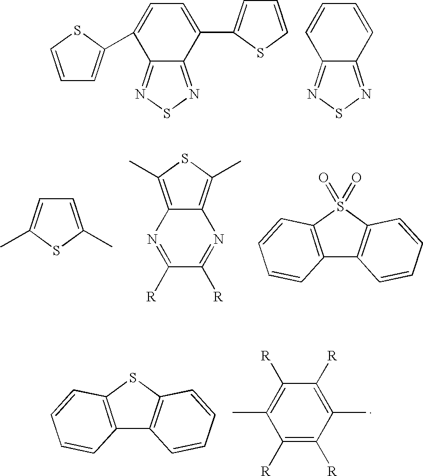

16. The composition of claim 15, wherein the copolymer comprises repeating dimer units, wherein each dimer unit comprises a DTP repeat unit and a non-DTP repeat unit which is represented by at least one of the following:

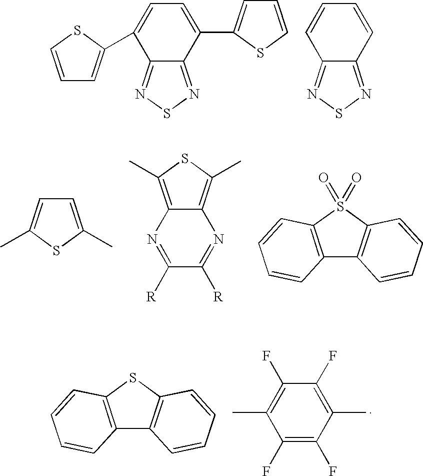

17. The composition of claim 15, wherein the non-DTP repeat unit which is represented by at least one of the following:

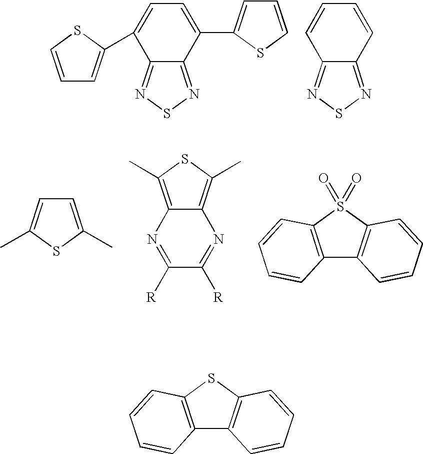

18. The composition of claim 1, wherein the copolymer is an alternating copolymer comprising at least one DTP repeat unit, which functions as an electron donor, and at least one non-DTP repeat unit, which functions as an electron acceptor.

19. The composition of claim 1, wherein the copolymer is an alternating copolymer represented by:

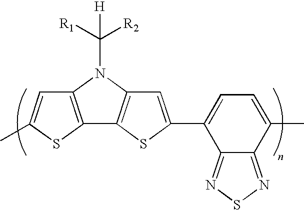

20. The composition of claim 1, wherein the copolymer comprises at least one non-DTP repeat unit which is represented by at least one of the following:

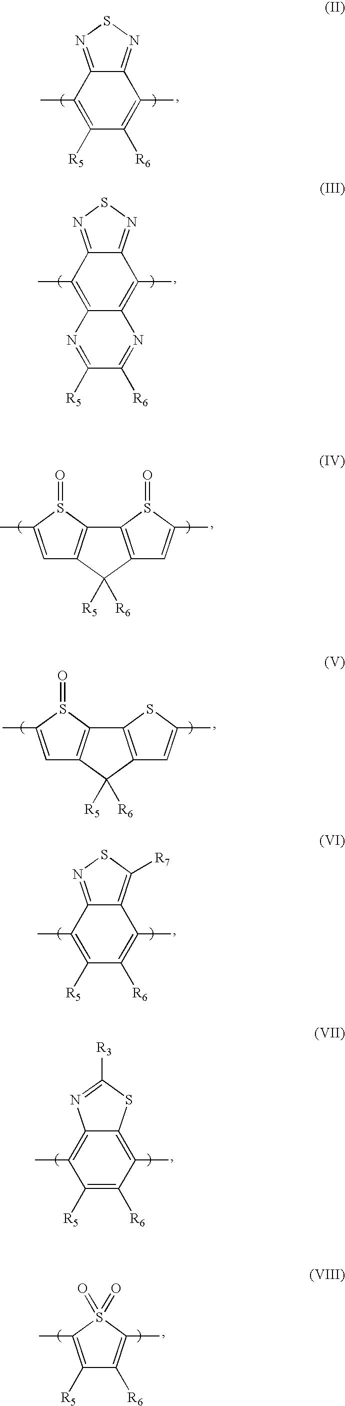

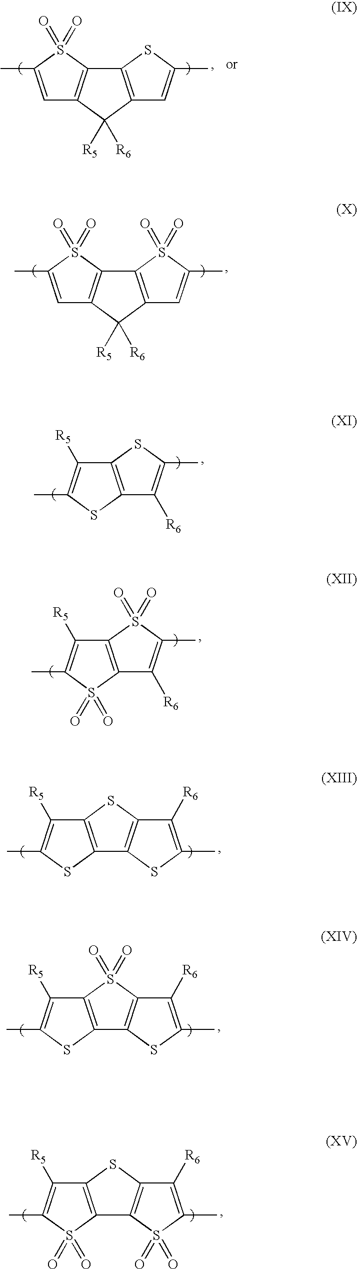

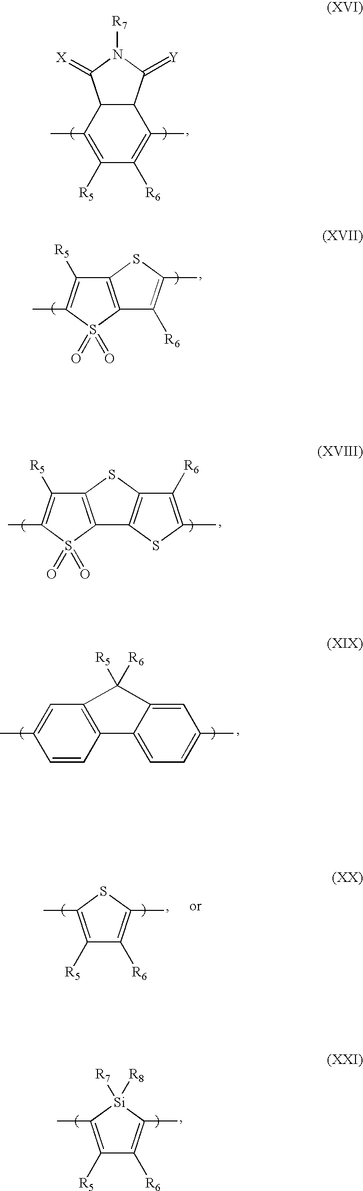

21. The composition of claim 1, wherein the copolymer comprises at least one non-DTP repeat unit which is represented by at least one of the following: 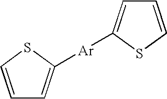
or: 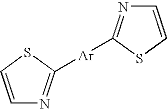
wherein Ar is represented by:

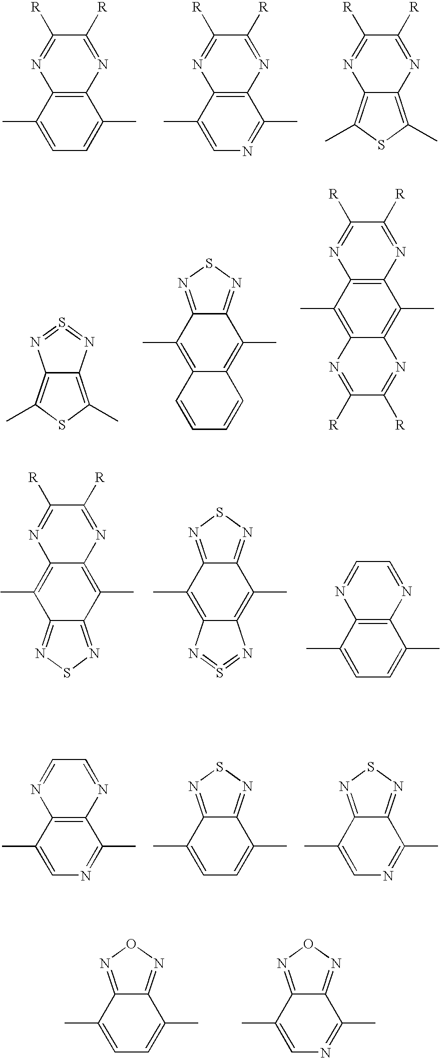

22. The composition of claim 1, the copolymer further comprising a silicon moiety.

23. The composition of claim 1, wherein the copolymer further comprises a silole moiety.

24. The composition of claim 1, the copolymer further comprising a moiety represented by: 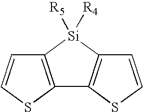
wherein R4 and R5 are independently optionally substituted alkyl, an optionally substituted aryl or heteroaryl, an optionally substituted alkenyl, or an optionally substituted alkynyl.

25. The composition of claim 24, wherein at least one of R4 or R5 is a branched alkyl.

26. The composition of claim 25, wherein R4 and R4 are branched alkyls.

26. An electronic device comprising the composition of claim 1.

27. The electronic device of claim 26, wherein the device is a photovoltaic cell.

28. The electronic device of claim 26, wherein the device is a photovoltaic cell and the active layer of the photovoltaic cell comprises the composition of claim 1.

29. The electronic device of claim 26, wherein the device is a field effect transistor.

30. The composition of claim 1, wherein the copolymer is resistant to oxidation in air.

31. A composition comprising a mixture comprising: (i) at least one p-type material, (ii) at least one n-type material, wherein the at least one p-type material comprises at least one copolymer, the copolymer comprising at least one first dithieno[3,2-b:2′,3′-d]pyrrole (DTP) repeat unit.

32. The composition according to claim 31, wherein the DTP repeat unit is represented by: 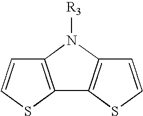
wherein R₃ is an optionally substituted alkyl, an optionally substituted aryl or heteroaryl, an optionally substituted alkenyl, or an optionally substituted alkynyl.

33. The composition according to claim 31, where in the DTP repeat unit is represented by: 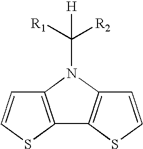
wherein R₁ and R₂ are independently an optionally substituted alkyl, an optionally substituted aryl or heteroaryl, an optionally substituted alkenyl, or an optionally substituted alkynyl.

34. The composition according to claim 31, wherein the DTP repeat unit is represented by: 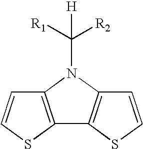
and R₁ and R₂ can be the same or different and are each an optionally substituted branched alkyl group.

35. The composition according to claim 34, wherein R₁ and R₂ are both 2-ethylhexyl groups.

36. The composition according to claim 31, wherein the copolymer comprises at least two different DTP units.

37. The composition according to claim 31, wherein the copolymer comprises repeating dimer units, wherein each dimer unit comprises a DTP repeat unit and a non-DTP repeat unit.

38. The composition according to claim 31, wherein the copolymer is an alternating copolymer comprising at least one DTP repeat unit, which functions as an electron donor, and at least one non-DTP repeat unit, which functions as an electron acceptor.

39. The composition according to claim 31, wherein the copolymer is an alternating copolymer represented by:

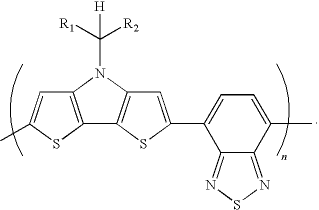

40. The composition of claim 31, wherein R₁ and R₂ are both 2-ethylhexyl groups.

41. The composition according to claim 31, wherein the copolymer further comprises a moiety represented by: 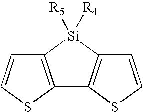
wherein R4 and R5 are independently optionally substituted alkyl, an optionally substituted aryl or heteroaryl, an optionally substituted alkenyl, or an optionally substituted alkynyl.

42. The composition according to claim 41, wherein at least one of R4 or R5 is a branched alkyl.

43. The composition according to claim 42, wherein R4 and R5 are branched alkyls.

44. The composition according to claim 31, wherein the at least one p-type material comprises copoly{N-[1(2′-ethylhexyl)-3-ethylheptanyl]dithieno[3,2-b;2′,3′-d]pyrrole-2,6-diyl-alt-4,7-di(2-thienyl)-2,1,3-benzothiadiazole-5′,5″-diyl}.

45. The composition according to claim 31, wherein the at least one n-type material comprises at least one fullerene derivative comprising at least one [6,6] fullerene bonding site wherein both carbon atoms of the [6,6] bonding site are covalently bonded to a group R.

46. The composition according to claim 45, wherein the group R comprises optionally substituted indene.

47. The composition according to claim 45, wherein the at least one n-type material comprises a C₆₀-indene adduct.

48. The composition according to claim 45, wherein the at least one n-type material comprises PCBM.

49. The composition according to claim 31, wherein the at least one copolymer is resistant to oxidation in air.

50. A composition comprising at least one dimer, the dimer comprising at least one first dithieno[3,2-b:2′,3′-d]pyrrole (DTP) repeat unit and at least one non-DTP repeat unit.

51. The composition according to claim 50, wherein the DTP repeat unit is represented by:

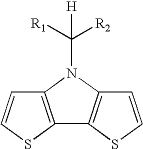

52. The composition according to claim 50, wherein the DTP repeat unit is represented by: 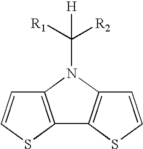
and R₁ and R₂ can be the same or different and are each an alkyl group.

53. The composition according to claim 50, wherein the DTP repeat unit is represented by: 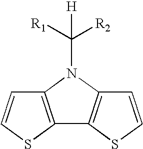
and R₁ and R₂ can be the same or different and are each a branched alkyl group.

54. The composition according to claim 50, wherein the non-DTP repeat unit comprises at least one ring structure.

55. The composition according to claim 50, wherein the non-DTP repeat unit comprises at least one fused ring structure.

56. The composition according to claim 50, wherein the non-DTP repeat unit comprises at least one aromatic ring structure.

57. The composition according to claim 50, wherein the non-DTP repeat unit comprises at least one substituted aromatic ring structure.

58. The composition according to claim 50, wherein the non-DTP repeat unit comprises at least one thiophene ring structure.

59. The composition according to claim 50, wherein the non-DTP repeat unit comprises at least one substituted thiophene ring structure.

60. The composition according to claim 50, wherein the non-DTP repeat unit is represented by at least one of the following:

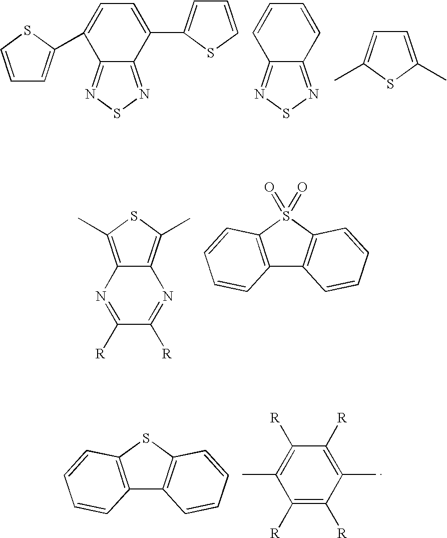

61. The composition according to claim 60, wherein the non-DTP repeat unit is represented by at least one of the following:

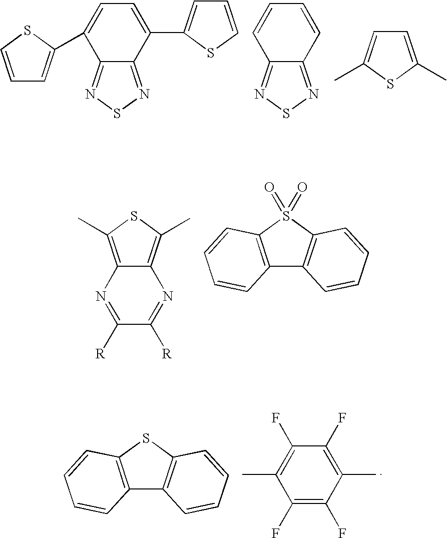

62. The composition according to claim 60, wherein the non-DTP repeat unit is represented by at least one of the following:

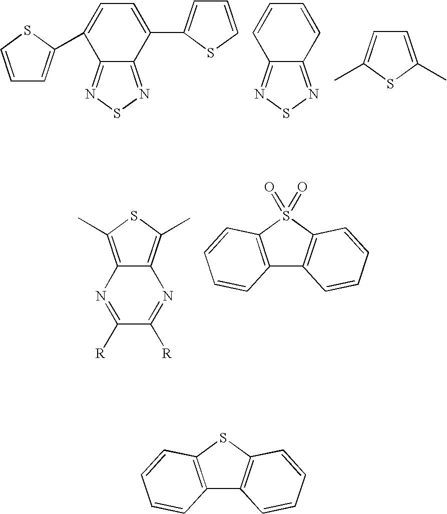

63. The composition according to claim 50, wherein the dimer comprises at least one DTP repeat unit, which functions as an electron donor, and at least one non-DTP repeat unit, which functions as an electron acceptor.

64. A composition prepared by polymerization of a composition according to claim 50.

65. The composition according to claim 64, wherein the composition is resistant to oxidation in air.

66. A method of making a composition comprising at least one dimer, the dimer comprising at least one first dithieno[3,2-b:2′,3′-d]pyrrole (DTP) repeat unit and at least one non-DTP repeat unit, the method comprising covalently linking the DTP repeat unit and the non-DTP repeat unit.

67. A composition comprising at least one dimer, the dimer comprising two different dithieno[3,2-b:2′,3′-d]pyrrole (DTP) repeat units.

68. A composition comprising at least one copolymer, the copolymer comprising at least one first dithieno[3,2-b:2′,3′-d]pyrrole (DTP) repeat unit, wherein the DTP repeat unit is represented by: 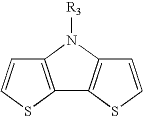
wherein R₃ is an optionally substituted alkyl, an optionally substituted aryl, an optionally substituted alkenyl, or an optionally substituted alkynyl; and the copolymer further comprises at least one non-DTP unit or at least one different DTP unit in the copolymer backbone.

69. An electronic device comprising a composition comprising at least one copolymer, the copolymer comprising at least one first dithieno[3,2-b:2′,3′-d]pyrrole (DTP) repeat unit.

70. The electronic device of claim 69, wherein the electronic device is a photovoltaic cell.

71. A composition comprising a mixture comprising: (i) at least one p-type material, (ii) at least one n-type material, wherein the at least one p-type material comprises copoly{N-[1(2′-ethylhexyl)-3-ethylheptanyl]dithieno[3,2-b;2′,3′-d]pyrrole-2,6-diyl-alt-4,7-di(2-thienyl)-2,1,3-benzothiadiazole-5′,5″-diyl} and wherein the at least one n-type material comprises at least one fullerene derivative comprising at least one [6,6] fullerene bonding site wherein both carbon atoms of the [6,6] bonding site are covalently bonded to a group R.

72. The composition according to claim 71, wherein the group R comprises optionally substituted indene.

73. The composition according to claim 71, wherein the at least one n-type material comprises a C₆₀-indene adduct.

74. The composition according to claim 71, wherein the at least one n-type material comprises PCBM.

75. A copolymer represented by:

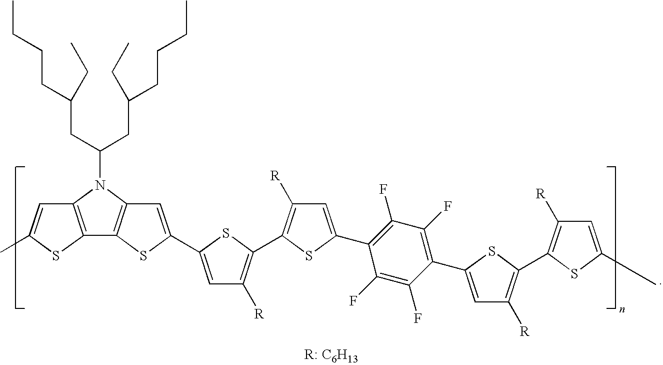

76. A composition comprising a mixture comprising: (i) at least one p-type material, (ii) at least one n-type material, wherein the at least one p-type material comprises at least one copolymer, the copolymer represented by: [chemical structure]
